(19) United States
(12) Patent Application Publication
(10) Pub. No.: US 2026/0154493 A1
(43) Pub. Date: Jun. 4, 2026

(54) SUGGESTING GENERATIVE CONTENT FOR A FORM DOCUMENT BASED ON CONSTRAINTS DETERMINED USING ML MODEL

(71) Applicant: GOOGLE LLC, Mountain View, CA (US)

(72) Inventors: Ajay Prasad, Bangalore (IN); Ramprasad Sedouram, Bangalore (IN); Gulmohar Khan, Bangalore (IN); Karthik Srinivas, Bangalore (IN)

(21) Appl. No.: 18/965,498

(22) Filed: Dec. 2, 2024

(51) Int. Cl. G06F 40/174; G06F 3/0484; G06F 3/0488

(52) U.S. Cl. CPC G06F 40/174; G06F 3/0484; G06F 3/0488

(57) ABSTRACT

Implementations set forth herein relate to an automated assistant that can provide generative content for form documents based on constraints determined for the form document. A constraint can include an express limitation provided in a form document, and/or a generative limitation that may not be expressly defined in the form document but may be determined from form document data. For example, a user that accesses a form document can be presented with certain interface outputs that can indicate generative content is available and satisfies a determined constraint. When the user selected to implement the generative content into a field of the form document, the generative content can be incorporated according to any constraints determined for the field and/or the form document. This can preserve resources that might otherwise be consumed switching between applications and/or manually identifying compliant inputs for the fields of the form document.

### BACKGROUND

Humans may engage in human-to-computer dialogs with interactive software applications referred to herein as “automated assistants” (also referred to as “digital agents,” “chatbots,” “interactive personal assistants,” “intelligent personal assistants,” “assistant applications,” “conversational agents,” etc.). For example, humans (which when they interact with automated assistants may be referred to as “users”) may provide commands and/or requests to an automated assistant using spoken natural language input (i.e., utterances), which may in some cases be converted into text and then processed, and/or by providing textual (e.g., typed) natural language input.

Despite the accessibility of computers around the world, many users with no prior experience with web interfaces and digital documents may have issues satisfying any limitations on what can or cannot be provided into a form document. Other issues that can arise when limitations are to be inferred by the type of form document, such as when a form document is to be submitted in a professional context, wherein a more professional linguistic style if preferred, or wherein a professional photograph is to be uploaded to the form document. Considerable computational resources can be wasted when users are unable to discern such inferences or express limitations, or such inferences are only understood after much progress has been made to fill out a form.

In some instances, the user may be required to restart the input process, which can cause a loss of data depending on an extent to which the user has completed the digital form. Such losses of data and resources can be especially critical in circumstances in which a novice user is using a digital fillable form to seek medical assistance—such as when a user signs up for a medical screening and/or other medical testing. Large language models (LLM) may be available through separate applications to generate content in response to a query, but this may require the user to frequently switch between a form document and an LLM-based application. This can be considerably inefficient, and waste time as well as memory for any affected device. Moreover, the separate LLM-based application may only be generating content based on what the user provides to the LLM-based application, rather than having a broader context of the interaction with the form document.

### SUMMARY

Implementations set forth herein relate to an automated assistant or other application that can use a generative model to determine constraints for a form document, and also provide generative content for fields in the form according to those constraints. The constraints can include, but are not limited to, one or more generative constraints and/or one or more express constraints. An express constraint can refer to a constraint that is expressly provided in a form document or otherwise expressly provided to a user that may interact with the form document. A generative constraint can refer to a different constraint that is determined using one or more sources of data, and/or that may not be expressly set forth in the form document. For example, a generative constraint can refer to a constraint that is generated using one or more generative models, such as a large language model (LLM), for determining an estimated or predicted intent or purpose of the form document. This intent can be characterized by a generative constraint, which can be used to suggest or otherwise provide a field input that satisfies the generative constraint. The field input can be generated to comply with any determined constraint and/or can be determined in in response to a query that is generated based on any determined constraint. For example, a retrieval-augmented response (RAG) process can be utilized generate a query for an LLM, and a responsive output can be the field input for the form document. Once constraints are determined for a form documents, those constraints can be stored in association with the form document for the benefit of any subsequent user of the form document. This can streamline filling out of form documents, thereby preserving resources for any application or device that provides access to the form document. For example, a subsequent user can access an empty version of the form document, but the determined constraints can be determined for the form document. Generative content can then be suggested for that subsequent user, such that the generative content complies with any previously determined constraints for the form document.

In some implementations, a field input can be generated, selected, and/or otherwise determined based on one or more generative constraints and/or one or more express constraints. As one non-limiting example, a user can be accessing a job application form document via an application, such as a browser or other computer application. The application form can ask a user to upload an image of themselves for attaching to their job application form. A generative model can be utilized, with prior permission from the user, to process form document data associated with the application form. This processing can result in a generative constraint being determined for an upload field corresponding to the request for the image of the user. In some implementations, the generative constraint can be set forth to limit a selected image to a professional image, such as an image that would be captured for a driver's license, passport, and/or or other professional photo (e.g., an image of a person facing forward in an environment with no other persons or objects). Alternatively, or additionally, the generative constraint can limit a selected image to an image that includes the user and/or an image from which an image of the user can be cropped.

In some implementations, when this generative constraint is determined, the automated assistant or other generative application can provide an interface output indicating that the automated assistant is available to select, suggest, and/or otherwise generate an input for the particular input field. In continuing with the image example, when the user selects the interface output or otherwise gives express permission to receive assistance with the form document, the automated assistant can determine whether an image is available that satisfies the generative constraint. For example, with prior permission from the user, the automated assistant can access images that the user has given the assistant express permission to access. The automated assistant can then use one or more machine learning models and/or one or more heuristic processes to determine whether any available images satisfy the generative constraint.

For example, the user may have a variety of images that do not include any persons, that do include multiple persons, and/or do include the user. Based on processing of these available images, the automated assistant can select a particular professional image that satisfies generative constraint that was determined for the application form (i.e., the form document). In some implementations, the automated assistant can suggest the selected image to the user and await confirmation that the user would like the selected image to be uploaded to the form document, or other application that is providing access to the form document. In some implementations, post-processing of a selected image can be performed to further ensure that the selected image complies with one or more generative constraints and/or express constraints determined for the form document. For example, a generative constraint and/or an express constraint for the image, as determined for the form document, may require a certain threshold of resolution, a certain threshold of white space, a size limitation, and/or other particular property for a data file. Based on these one or more constraints, the automated assistant can employ one or more heuristic processes and/or one or more machine learning models to further process the image to create an updated image that can be uploaded to the form document.

In some implementations, one or more express constraints and/or one or more generative constraints can be determined for a form document and be utilized to assist with inputting text and/or other input to the form document. In continuing with the job application example, a particular field of the form document may solicit the user to provide a description of recent projects they worked on throughout their career. A generative constraint for the form document can be utilized to suggest content that embodies a tone or linguistic style that is more professional or otherwise suitable for a job application. Additionally, an express constraint determined for the form document can indicate that the particular field should be limited to 500 words. Therefore, based on the generative constraint and the express constraint, content suggested by the automated assistant can be generated to comply with both limitations.

The suggested content can be generated based on: content that the user has already input into the form document, form document data that is stored in association with the form document, data that the user has given the automated assistant permission to access, and/or any other data that other users have given express permission for the automated assistant to access. For example, when filling out the job application, the user may list generic terms for the projects they worked on during their career. This list of projects, and any other data the that the user has permitted the automated assistant to access, can be processed using one or more generative models to generate one or more suggestions for input to the particular field.

In some implementations, when the generative content has been generated and is available for suggesting to the user, an interface output can be rendered at the application that is providing access to the form document. The user can then select the interface output, or otherwise interact with the application or automated assistant, to confirm their willingness to utilize the suggested generative content. Upon confirmation that the user is willing to utilize the generative content, the automated assistant application can supplement the particular field, or replace content in the particular field, with the generative content.

In some implementations, the automated assistant can provide one or more selectable elements for adjusting parameters (e.g., temperature, number of tokens, sampling, style, penalty, weight, threshold, etc.) of the constraints and/or other parameters utilized to generate the generative content. For example, when the user has selected to utilize the project summaries generated by the automated assistant, one or more selectable elements can be available for adjusting the project summaries. A selectable element can be, for example, a GUI element that the user can interact with to adjust the generative content. For example, interacting with a particular GUI element can make the generative content more strictly adhere to the generative constraint or less strictly adhere to the generative constraint. When the generative constraint is determined to ensure that generative content sounds more professional, adjusting the GUI element can cause the generative content to be either more professional sounding, or less professional sounding. Alternatively, or additionally, another GUI element can be available for adjusting one or more parameters associated with an express constraint determined by the automated assistant. For example, when the express constraint is associated with a word count for the particular field, the user can interact with the GUI element to cause the generative content to include more words or less words. In some instances, the entire field may be replaced with other generative content because the interaction with the GUI element modified parameters that necessitated such replacement. Alternatively, in some instances, a percentage of the generative content may remain the same while some of the generative content may be modified or replaced according to the one or more parameters that were adjusted for one or more particular constraints.

The above description is provided as an overview of some implementations of the present disclosure. Further description of those implementations, and other implementations, are described in more detail below.

Other implementations may include a non-transitory computer readable storage medium storing instructions executable by one or more processors (e.g., central processing unit(s) (CPU(s)), graphics processing unit(s) (GPU(s)), and/or tensor processing unit(s) (TPU(s)) to perform a method such as one or more of the methods described above and/or elsewhere herein. Yet other implementations may include a system of one or more computers that include one or more processors operable to execute stored instructions to perform a method such as one or more of the methods described above and/or elsewhere herein.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1A, FIG. 1B, FIG. 1C, FIG. 1D, and FIG. 1E illustrate views of a user interacting with interface elements to adjust generative content according to one or more determined constraints for a form document.

FIG. 2 illustrates a system that can use a generative model to determine constraints for a form document, and provide generative content for fields in the form according to those constraints.

FIG. 3 illustrates a method for providing or form document based on one or more constraints determined by one or more generative models.

FIG. 4 is a block diagram of an example computer system.

### DETAILED DESCRIPTION

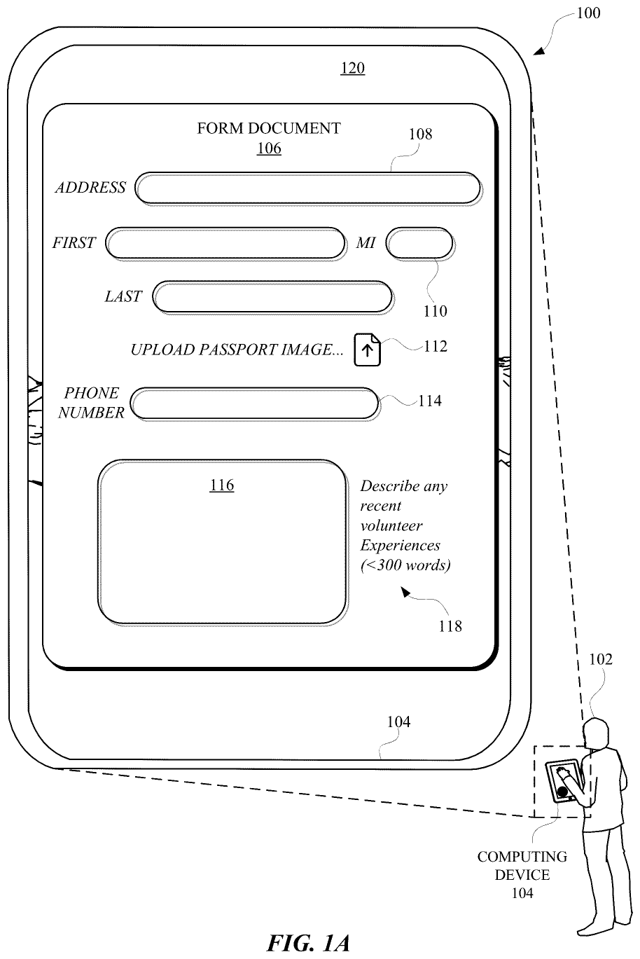

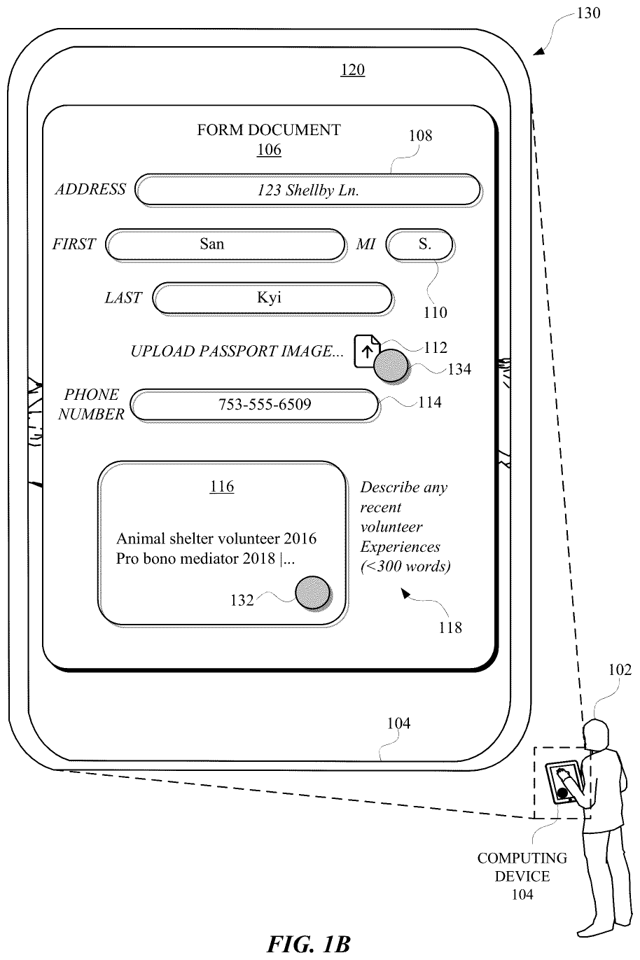

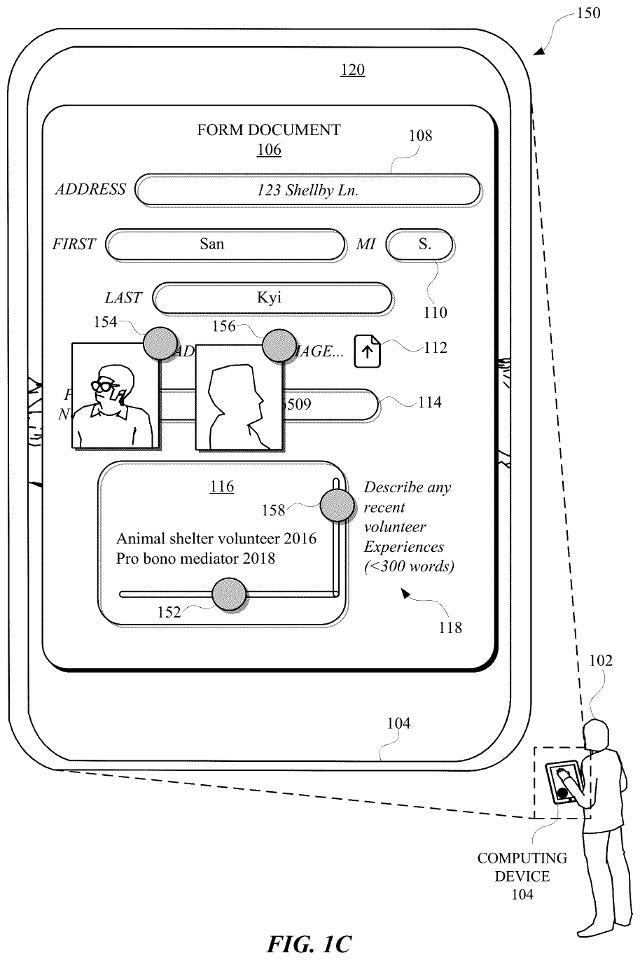

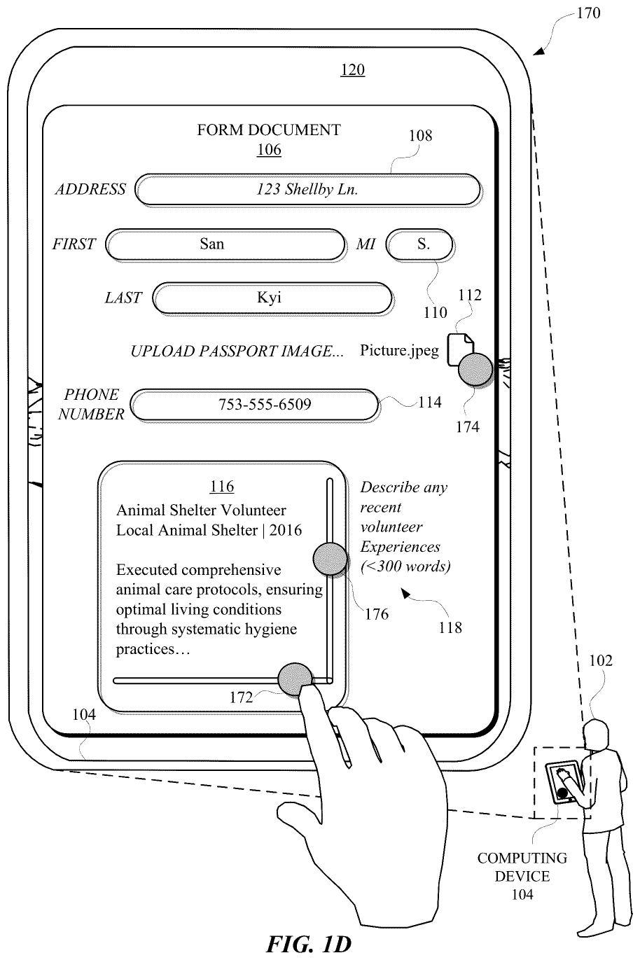

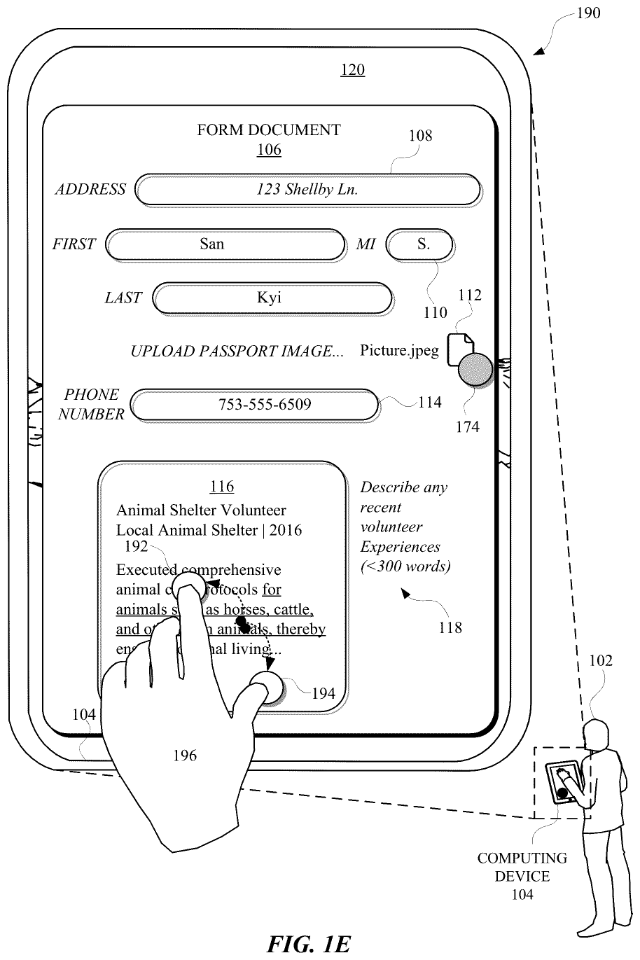

FIG. 1A, FIG. 1B, FIG. 1C, FIG. 1D, and FIG. 1E illustrate views 100, 130, 150, 170, and 190 respectively, of a user 102 interacting with interface elements to adjust generative content according to one or more determined constraints for a form document 106. The form document 106 can be rendered at a display interface 120 by an application that is accessible via a computing device 104 that also provides access to an automated assistant or other application that relies on a generative model. The form document 106 can be, for example, a job application, registration form, and/or any other form document that a user 102 can fill out by providing input, selecting a file, and/or otherwise fulfilling requests set forth in the form document 106.

For example, the form document 106 can include various fields for entering an address 108, a middle initial 110, a phone number 114, a description 116 of recent experiences, and also an option to upload 112 an image. Content of the form document 106, and other data associated with the form document 106 (e.g., HTML code, DOM table, application meta data, etc.) can be processed using one or more machine learning models to determine one or more constraints for the form document 106. The one or more constraints can include, but are not limited to, one or more generative limitations and one or more express limitations. For example, an express limitation can be based on some express content 118 of the form document 106 that indicates a limitation of one or more fields of the form document 106 (e.g., less than 300 words). A generative limitation may not be based on a single expression of a limitation in a form document 106, but may be based on processing of form document data by a machine learning model, such as a generative model. For example, the form document 106 may not include an express limitation requiring a user to provide inputs that reflect a professional tone. However, the form document data can otherwise reflect an intention that the form document 106 should be filled in with inputs that appear more professional (e.g., more professional relative to other types of form documents, or other types of inputs).

In some implementations, the automated assistant can determine, with prior permission from the user 102, that the user 102 is accessing a form document 106 and process form document data 106 for determining generative content. Processing the form document data can result in a determination of one or more constraints for one or more fields of the form document 106. For example, one or more constraints can include one or more express constraints that can limit the generative content for a particular field to only certain types and/or forms of content. For instance, a field for the phone number 114 can be limited to numbers and/or limited to a certain quantity of characters. Alternatively, or additionally, a field for an address 108 can be limited to a string that represents an address (e.g., [house number] [street], [city], [state], [code]). In some implementations, these constraints on the phone number 114 and address 108 fields can be express constraints determined by the automated assistant. However, the automated assistant can also determine generative constraints.

A generative constraint for the form document 106 may not be expressly defined in the form document 106 but may be determined from one or more different portions of form document data. For example, even though the form document 106 does not expressly state it is a job application, the automated assistant may infer that the form document 106 is a job application based on form document data, including contextual data and other data stored in association with the form document 106. For instance, the user 102 may be accessing the form document 106 via a job search application and/or a job website. Alternatively, or additionally, historical data (accessible to the automated assistant with prior express permission from the user 102) can also indicate that the user 102 has recently been looking at job postings on the internet. Based on processing this information, the automated assistant can determine a generative constraint for the form document 106.

When one or more constraints are determined for the form document 106, the automated assistant can generate generative content that is at least partially based on the form document 106. When generative content is determined to be available for a particular field of the form document 106, the automated assistant can cause an interface output to be rendered at the display interface 120 and/or another interface of the computing device 104 or another computing device. For example, a GUI element 134 and a GUI element 132 can be rendered at or near different fields of the form document 106 to indicate that generative content is available for incorporating into each respective field. In some implementations, the GUI element 132 can be provided in association with generative content that satisfies a generative constraint that includes an express limitation and a generative limitation. The generative content can be based on the form document data as well as any additional data that the user 102 has input into the form document 106. For example, the user 102 may have provided some draft content into a field for a description 116, and the draft content can be processed to determine the generative content that also complies with the generative constraint. For instance, the user 102 may have written an outline in the field for the description 116, and the outline can be processed with the form document data to determine generative content to suggest to the user 102 for the description 116. In response to the user 102 selecting the GUI element 132, the generative content can be incorporated into the field for the description 116, as illustrated in FIG. 1C.

In some implementations, the automated assistant can process the form document data to determine one or more constraints for a file or other snippet of data to be uploaded to the form document 106. For example, a constraint can indicate that an image to be uploaded to the form document 106 should be a passport image and/or other professional image. The constraint can be based on a determined express limitation that the image be a “passport image” (e.g., includes a single person with an empty background) and a generative limitation that the person in the image appear professional. The automated assistant can identify one or more files that can be uploaded to the form document 106 and that satisfy the constraint for the field of the form document 106 that asks the user 102 to upload an image. For example, files that the user 102 has given the automated assistant express permission to access can be processed by the automated assistant to determine a suitable file that satisfies one or more constraints determined for the form document 106. For instance, one or more images can be processed using one or more machine learning models and/or one or more heuristic processes to determine that an image satisfies one or more express limitations and/or generative limitations for the form document 106.

In some implementations, the automated assistant can provide the user 102 with one or more options of files to upload to the form document 106, as illustrated in FIG. 1C. Alternatively, or additionally, the automated assistant can select a file to upload to the form document 106 without providing multiple different options to select from. As illustrated in FIG. 1C, the automated assistant can select a first image 154 and a second image 156 for presenting to the user 102 as candidate files to submit to a field of the form document 106. The user 102 can then select a particular file for submitting to the form document 106. In some implementations, a file identified by the automated assistant can be modified according to the one or more constraints identified for the form document 106. For example, generative content can be generated as an image that is based on one or more identified images and the form document data. For example, if a user 102 does not have an image of themselves with a clear background, the automated assistant can select an image to modify in furtherance of creating an image that satisfies the one or more constraints.

In some implementations, one or more adjustable interface elements 152 can be utilized to modify one or more parameters for creating the generative content. In some implementations, a parameter that is modifiable by the adjustable interface element 152 can influence how many words are in a snippet of generative text. Alternatively, or additionally, adjusting the parameter can modify a tone parameter and/or linguistic profile parameter of the generative text. Alternatively, or additionally, the adjustable interface element 152 can influence one or more parameters of a generative model, thereby affecting an output that is suggested to the user 102. In this way, the user 102 does not have to copy and paste the generative text into a separate application for adjusting via an LLM. Rather, various parameters can be adjusted via various GUI elements rendered at the form document 106.

For example, in response to the user 102 interacting with the interface element 152, the generative content in the field can be modified or replaced, as shown in FIG. 1D. As shown in FIG. 1D, the user 102 can adjust the interface element 152 to another position 172, thereby causing one or more parameters for generating content to be adjusted. As a result, the updated generative content in the field for the description 116 may still comply with the express limitation, but also more strictly or less strictly comply with a generative limitation. For instance, the linguistic style of the generative content can become more or less professional depending on the degree to which the user 102 interacted with the interface element 152.

In some implementations, as the user 102 adjusts a particular interface element, the automated assistant can regenerate content based on any adjustments. For example, in response to the user 102 adjusting the interface element 152, the automated assistant can determine that the form document data exhibits more professional conduct. Based on this determination, the automated assistant can cause one or more interface outputs to be rendered for suggesting other content to provide into certain fields of the form document. For instance, in response to the user 102 adjusting the interface element 152 to be in a different position 172, the automated assistant can render a suggestion 174 for uploading a different image to the form document 106. In this way, the user 102 can avoid having to manually modify each field as their progress in the form document 106 continues. Rather, each adjustment to an interface element can indicate to the automated assistant certain preferences of the user 102 with respect to the form document 106. Those adjustments can then be processed with the form document data to generate the updated generative content.

In some implementations, the automated assistant can facilitate various gestures that allow the user 102 to interact with generative content for the form document 106, as illustrated in view 190 of FIG. 1E. Gestures can be performed using one or more appendages of the user 102, stylus, and/or other object. For example, a gesture can be performed at the display interface 120 that is rendering the form document 106 to modify content of the form document 106. As illustrated in FIG. 1E, the user 102 can motion their hand 196 and/or one or more fingers to modify generative content that the user selected to incorporate into the field for the description 116. For instance, the user 102 can perform a pinching or expanding motion with their thumb and first finger starting at a common location and ending at two different locations (e.g., location 192 and location 194). As a result, the content provided in the field at the starting location can be adjusted according to a degree to which the user 102 pinched, expanded, or otherwise moved their fingers.

The gesture can cause one or more parameters of a generative model to be modified in furtherance of generating alternative generative content to be incorporated into the description 116. For instance, and as illustrated in FIG. 1D and FIG. 1E, the gesture can begin at the text “animal care protocols” and thereby cause a modification to the text “animal care protocols. The gesture can indicate processing of form document data, including the existing content in the field for the description 116, other content of other fields of the form document 106, and/or other data that the automated assistant can access with prior express permission from the user 102. For example, based on the user 102 having a stored resume that indicates particular animals the user 102 has worked with, updated generative content can be provided to replace that text that was subject to the gesture. As illustrated in FIG. 1E, as the user 102 performs the gesture with their hand 196, the updated generative content can replace or supplement the initial generative content (e.g., “animal care protocols” can be supplemented with “for animals such as horses, cattle, and other farm animals, thereby”).

In some implementations, the updated generative content can be generated to satisfy any constraints determined for the form document 106. For example, the updated generative content can be supplemented at the field for the description 116 without causing the entire content of the field to exceed the express limitation of being less than 300 words. Additionally, the updated generative content can be generated to comply with any adjusted parameters for satisfying the generative constraint determined for the form document 106. For example, the automated assistant can determine that the user 102 is requesting that a portion of some generative content be supplemented and, in response, the automated assistant can determine content to remove from the field and content that is professional. When the gesture is being performed, the modifications to the generative content can be rendered in real-time, thereby allowing the user 102 to know when to keep performing the gesture or to stop or reverse the gesture.

In some implementations, the gesture can be a swipe gesture, tap gesture, long-press gesture, and/or any other type of gesture that can be understood by an automated assistant. In some implementations, when the user 102 performs a swipe gesture at a candidate image shown in FIG. 1C, the gesture can cause the automated assistant to identify other images similar to the candidate image that received the gesture. The other images can then be identified by the automated assistant in response to the gesture and in accordance with any constraint determined for the form document 106. For example, when a swipe gesture is received at the second image 156, the first image 154 can be replaced with a third image, but one that resembles the second image 156 than the first image 154. Thereafter, the user 102 can perform another gesture (e.g., a tap gesture) to select the third image for uploading to the form document 106 and/or application providing access to the form document 106. In some implementations, any selections of generative content can be characterized by training data that can be used to train a generative model, with prior permission from the user 102. Thereafter, when the user 102 accesses the same or a different form document, the generative model can provide more accurate suggestions of content for fields of the form document, and more accurately detect constraints for form documents.

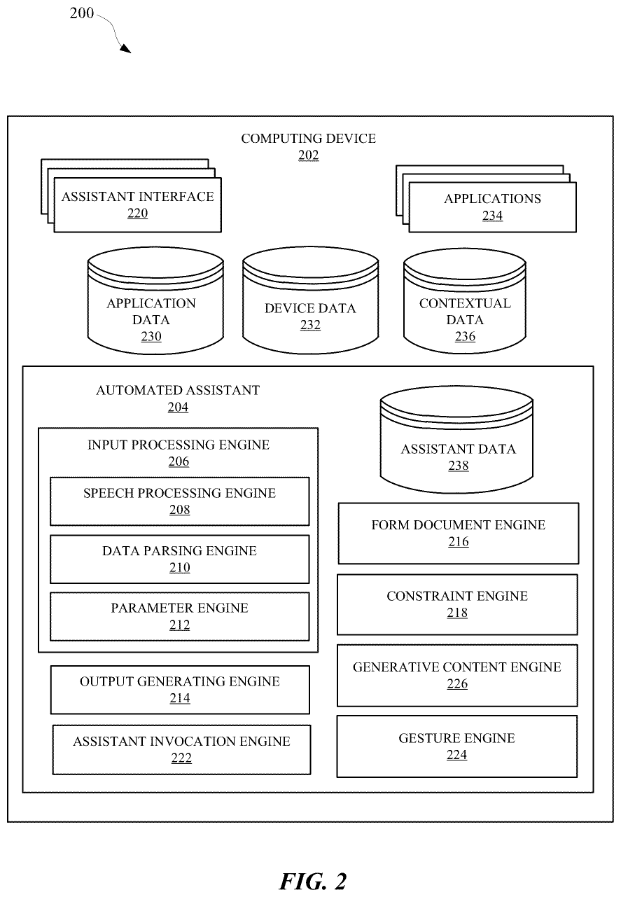

FIG. 2 illustrates a system 200 that can use a generative model to determine constraints for a form document, and provide generative content for fields in the form according to those constraints. In some implementations, a user can interact with an automated assistant 204 to cause the generative content to be provided for the form document. The generative content can be generated in response to a query that is developed as part of a RAG process that is at least partially based on any determined constraint and/or any other contextual data associated with the user (e.g., personal knowledge graph, cloud-stored documents, etc.) and/or the form document, with prior permission from the user. The automated assistant 204 can operate as part of an assistant application that is provided at one or more computing devices, such as a computing device 202 and/or a server device. A user can interact with the automated assistant 204 via assistant interface(s) 220, which can be a microphone, a camera, a touch screen display, a user interface, and/or any other apparatus capable of providing an interface between a user and an application. For instance, a user can initialize the automated assistant 204 by providing a verbal, textual, and/or a graphical input to an assistant interface 220 to cause the automated assistant 204 to initialize one or more actions (e.g., provide data, control a peripheral device, access an agent, generate an input and/or an output, etc.). Alternatively, the automated assistant 204 can be initialized based on processing of contextual data 236 using one or more trained machine learning models. The contextual data 236 can characterize one or more features of an environment in which the automated assistant 204 is accessible, and/or one or more features of a user that is predicted to be intending to interact with the automated assistant 204. The computing device 202 can include a display device, which can be a display panel that includes a touch interface for receiving touch inputs and/or gestures for allowing a user to control applications 234 of the computing device 202 via the touch interface. In some implementations, the computing device 202 can lack a display device, thereby providing an audible user interface output, without providing a graphical user interface output. Furthermore, the computing device 202 can provide a user interface, such as a microphone, for receiving spoken natural language inputs from a user. In some implementations, the computing device 202 can include a touch interface and can be void of a camera, but can optionally include one or more other sensors.

The computing device 202 and/or other third party client devices can be in communication with a server device over a network, such as the internet. Additionally, the computing device 202 and any other computing devices can be in communication with each other over a local area network (LAN), such as a Wi-Fi network. The computing device 202 can offload computational tasks to the server device in order to conserve computational resources at the computing device 202. For instance, the server device can host the automated assistant 204, and/or computing device 202 can transmit inputs received at one or more assistant interfaces 220 to the server device. However, in some implementations, the automated assistant 204 can be hosted at the computing device 202, and various processes that can be associated with automated assistant operations can be performed at the computing device 202.

In various implementations, all or less than all aspects of the automated assistant 204 can be implemented on the computing device 202. In some of those implementations, aspects of the automated assistant 204 are implemented via the computing device 202 and can interface with a server device, which can implement other aspects of the automated assistant 204. The server device can optionally serve a plurality of users and their associated assistant applications via multiple threads. In implementations where all or less than all aspects of the automated assistant 204 are implemented via computing device 202, the automated assistant 204 can be an application that is separate from an operating system of the computing device 202 (e.g., installed “on top” of the operating system)—or can alternatively be implemented directly by the operating system of the computing device 202 (e.g., considered an application of, but integral with, the operating system).

In some implementations, the automated assistant 204 can include an input processing engine 206, which can employ multiple different modules for processing inputs and/or outputs for the computing device 202 and/or a server device. For instance, the input processing engine 206 can include a speech processing engine 208, which can process audio data received at an assistant interface 220 to identify the text embodied in the audio data. The audio data can be transmitted from, for example, the computing device 202 to the server device in order to preserve computational resources at the computing device 202. Additionally, or alternatively, the audio data can be exclusively processed at the computing device 202.

The process for converting the audio data to text can include a speech recognition algorithm, which can employ neural networks, and/or statistical models for identifying groups of audio data corresponding to words or phrases. The text converted from the audio data can be parsed by a data parsing engine 210 and made available to the automated assistant 204 as textual data that can be used to generate and/or identify command phrase(s), intent(s), action(s), slot value(s), and/or any other content specified by the user. In some implementations, output data provided by the data parsing engine 210 can be provided to a parameter engine 212 to determine whether the user provided an input that corresponds to a particular intent, action, and/or routine capable of being performed by the automated assistant 204 and/or an application or agent that is capable of being accessed via the automated assistant 204. For example, assistant data 238 can be stored at the server device and/or the computing device 202, and can include data that defines one or more actions capable of being performed by the automated assistant 204, as well as parameters necessary to perform the actions. The parameter engine 212 can generate one or more parameters for an intent, action, and/or slot value, and provide the one or more parameters to an output generating engine 214. The output generating engine 214 can use the one or more parameters to communicate with an assistant interface 220 for providing an output to a user, and/or communicate with one or more applications 234 for providing an output to one or more applications 234.

In some implementations, the automated assistant 204 can be an application that can be installed “on-top of” an operating system of the computing device 202 and/or can itself form part of (or the entirety of) the operating system of the computing device 202. The automated assistant application includes, and/or has access to, on-device speech recognition, on-device natural language understanding, and on-device fulfillment. For example, on-device speech recognition can be performed using an on-device speech recognition module that processes audio data (detected by the microphone(s)) using an end-to-end speech recognition machine learning model stored locally at the computing device 202. The on-device speech recognition generates recognized text for a spoken utterance (if any) present in the audio data. Also, for example, on-device natural language understanding (NLU) can be performed using an on-device NLU module that processes recognized text, generated using the on-device speech recognition, and optionally contextual data, to generate NLU data.

NLU data can include intent(s) that correspond to the spoken utterance and optionally parameter(s) (e.g., slot values) for the intent(s). On-device fulfillment can be performed using an on-device fulfillment module that utilizes the NLU data (from the on-device NLU), and optionally other local data, to determine action(s) to take to resolve the intent(s) of the spoken utterance (and optionally the parameter(s) for the intent). This can include determining local and/or remote responses (e.g., answers) to the spoken utterance, interaction(s) with locally installed application(s) to perform based on the spoken utterance, command(s) to transmit to internet-of-things (IoT) device(s) (directly or via corresponding remote system(s)) based on the spoken utterance, and/or other resolution action(s) to perform based on the spoken utterance. The on-device fulfillment can then initiate local and/or remote performance/execution of the determined action(s) to resolve the spoken utterance.

In various implementations, remote speech processing, remote NLU, and/or remote fulfillment can at least selectively be utilized. For example, recognized text can at least selectively be transmitted to remote automated assistant component(s) for remote NLU and/or remote fulfillment. For instance, the recognized text can optionally be transmitted for remote performance in parallel with on-device performance, or responsive to failure of on-device NLU and/or on-device fulfillment. However, on-device speech processing, on-device NLU, on-device fulfillment, and/or on-device execution can be prioritized at least due to the latency reductions they provide when resolving a spoken utterance (due to no client-server roundtrip(s) being needed to resolve the spoken utterance). Further, on-device functionality can be the only functionality that is available in situations with no or limited network connectivity.

In some implementations, the computing device 202 can include one or more applications 234 which can be provided by a third-party entity that is different from an entity that provided the computing device 202 and/or the automated assistant 204. An application state engine of the automated assistant 204 and/or the computing device 202 can access application data 230 to determine one or more actions capable of being performed by one or more applications 234, as well as a state of each application of the one or more applications 234 and/or a state of a respective device that is associated with the computing device 202. A device state engine of the automated assistant 204 and/or the computing device 202 can access device data 232 to determine one or more actions capable of being performed by the computing device 202 and/or one or more devices that are associated with the computing device 202. Furthermore, the application data 230 and/or any other data (e.g., device data 232) can be accessed by the automated assistant 204 to generate contextual data 236, which can characterize a context in which a particular application 234 and/or device is executing, and/or a context in which a particular user is accessing the computing device 202, accessing an application 234, and/or any other device or module.

While one or more applications 234 are executing at the computing device 202, the device data 232 can characterize a current operating state of each application 234 executing at the computing device 202. Furthermore, the application data 230 can characterize one or more features of an executing application 234, such as content of one or more graphical user interfaces being rendered at the direction of one or more applications 234. Alternatively, or additionally, the application data 230 can characterize an action schema, which can be updated by a respective application and/or by the automated assistant 204, based on a current operating status of the respective application. Alternatively, or additionally, one or more action schemas for one or more applications 234 can remain static, but can be accessed by the application state engine in order to determine a suitable action to initialize via the automated assistant 204.

The computing device 202 can further include an assistant invocation engine 222 that can use one or more trained machine learning models to process application data 230, device data 232, contextual data 236, and/or any other data that is accessible to the computing device 202. The assistant invocation engine 222 can process this data in order to determine whether or not to wait for a user to explicitly speak an invocation phrase to invoke the automated assistant 204, or consider the data to be indicative of an intent by the user to invoke the automated assistant—in lieu of requiring the user to explicitly speak the invocation phrase. For example, the one or more trained machine learning models can be trained using instances of training data that are based on scenarios in which the user is in an environment where multiple devices and/or applications are exhibiting various operating states. The instances of training data can be generated in order to capture training data that characterizes contexts in which the user invokes the automated assistant and other contexts in which the user does not invoke the automated assistant. When the one or more trained machine learning models are trained according to these instances of training data, the assistant invocation engine 222 can cause the automated assistant 204 to detect, or limit detecting, spoken invocation phrases from a user based on features of a context and/or an environment.

In some implementations, the system 200 can include a form document engine 216 that can process form document data for determining whether a user is accessing a form document and/or other interface that includes one or more fields for the user to provides inputs to. The form document data can include content of the form document, data stored in association with the form document, contextual data associated with the user (e.g., personal knowledge graph data, local documents that the user recently accessed), and/or any other data that can characterize an interaction with a form document (e.g., historical interaction data), with prior express permission from the user. In some implementations, the form document data can be processed using one or more machine learning models and/or one or more heuristic processes. For example, the form document data can include data characterizing a document object model (DOM) that can indicate a hierarchy of fields of a form document.

Based on this processing of the form document data, a constraint engine 218 of the system 200 can determine one or more constraints for the form document. For example, a constraint can include an express limitation that is expressly characterized by content rendered with the form document and/or otherwise stored in association with the form document. In some implementations, a constraint can include a generative constraint that can characterize a limitation determined using a generative model. For example, one or more trained machine learning models can be utilized to process the form document data to determine generative constraints for one or more fields of the form document. The generative constraints may or may not be expressly described by a single instance of content of the form document, but may otherwise be determined by such processing. For example, at least a portion of form document data can be processed to generate an embedding that can be mapped to a latent space. The latent space can include other embeddings that are associated with certain types of form documents and/or certain constraints. When a distance between embeddings satisfies a threshold distance, the corresponding generative constraint can be determined for the form document that served as the basis for the generated embedding.

In some implementations, the system 200 can include a generative content engine 226 that can provide generative content based on the one or more constraints determined for the form document. The generative content can also be determined based on any input that the user has provided to the form document, and that may be part of the form document data. In some implementations, the generative content can be generated according to a RAG process in which the determined constraint is utilized to provide a more accurate query for an LLM. In some implementations, when the form document engine 216 determines that the user is accessing a form document, the generative content engine 226 can provide an interface output that can indicate generative content may be available for providing to one or more fields of the form document. In some implementations, pre-processing of the form document data can be performed with prior permission from the user for suggesting generative content for a particular field. This generative content can be generated in accordance with any constraint determined by the constraint engine 218.

When a user interacts with an interface output, the automated assistant 204 can determine a particular field that a user may be interested in supplementing with generative content. For example, an interface output can include one or more GUI elements that are rendered at or near a field of the form document. A GUI element that is rendered can be interacted with by the user to cause generative content to be incorporated into the field, and/or to modify content that is already provided in the field. For example, a swipe gesture at a GUI element can cause any existing content of the field to be more or less compliant with a determined constraint for the field (e.g., more professional sounding or less professional sounding, more words or less words, etc.).

The system 200 can include a gesture engine 224 that can determine a gesture performed by the user, and generate data that can indicate how to modify any content of the form document according to the gesture. For example, a long-press or tap gesture at a particular field of a form document can cause the automated assistant 204 to render a suggestion for generative content to incorporate into the particular field. The user can then select a GUI suggestion element for confirming their interest in having the generative content incorporated into the particular field. Otherwise, when the user does not interact with the GUI suggestion element within a threshold duration of time, the GUI suggestion element may be no longer rendered. In some implementations, as the user interacts with generative content and/or other form documents, training data can be generated for further training any generative models that are used when preparing form documents. This training data can be generated with prior express permission from the user, and can make subsequent interactions more accurate, thereby saving time and resources of the user and any applications involved in filling out form documents.

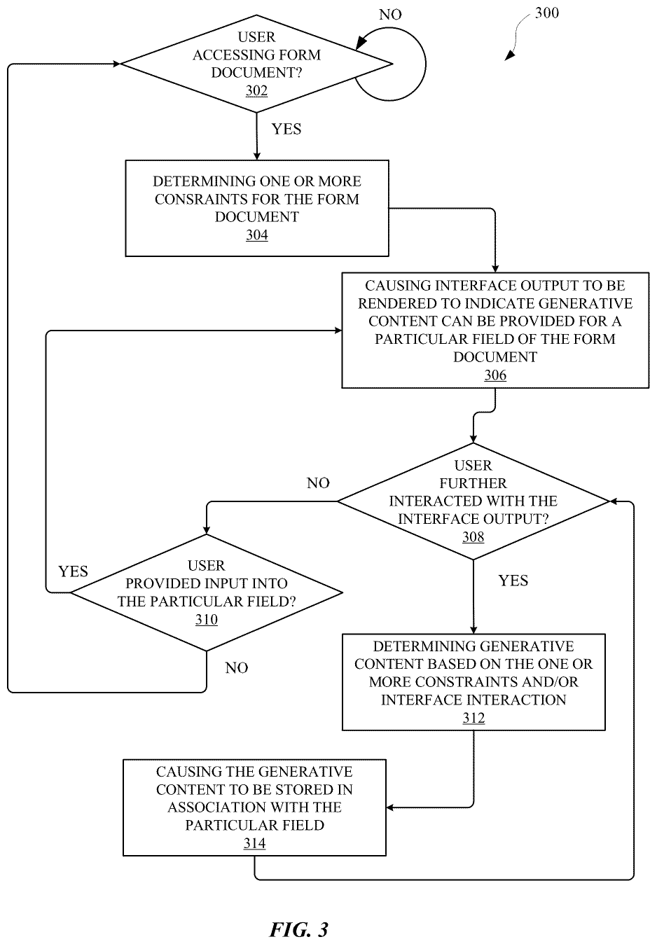

FIG. 3 illustrates a method 300 for providing or form document based on one or more constraints determined by one or more generative models. In some implementations, a constraint can be, but is not limited to, an express constraint or a generative constraint, which can be determined by one or more heuristic processes and/or one or more trained to machine learning models. The method 300 can be performed by one or more applications, computing devices, and/or any other apparatus or module capable of interacting with an automated assistant. The method 300 can include an operation 302 of determining whether a user is accessing a form document, such as a document that is available via a web browser or other computer application. The form document can include one or more fields, text, and/or any other content that is accessible via the form document or otherwise stored in association with the form document.

When a user is determined to be accessing the form document, the method 300 can proceed from the operation 302 to an operation 304. The operation 304 can include determining one or more constraints for the form document. In some implementations, determining a constraint can involve processing content that is rendered at the form document and/or otherwise processing data that is associated with the form document. For example, text within, adjacent to, and/or otherwise visible near fields of the form document can be processed, with prior permission from the user, in furtherance of determining one or more constraints for the form document. Alternatively, or additionally, one or more images, videos, and/or other content available at the form document, or otherwise associated with the form document, can be processed for determining the one or more constraints.

In some implementations, the one or more constraints can include an express constraint and/or a generative constraint. An express constraint can refer to a restriction or other parameter or rule that may be expressly provided within the form document or otherwise expressly associated with the form document. In some implementations, a generative constraint can be based on content of the form, document, and/or any other content associated with the form document. The generative constraint may or may not be expressly set forth in the form document and/or can be determined using one or more trained machine learning models. In some implementations, a model used to determine an express constraint or a generative constraint can be trained using training data that is generated based on prior interactions with the form document, either by the same user and/or one or more other users.

The method 300 can proceed from the operation 304 to an operation 306. The operation 306 can include causing an interface output to be rendered to indicate generative content that can be provided for a particular field of the form document. For example, based on the one or more constraints determined for the form document, one or more generative models can be utilized to generate content for one or more fields of the form document. This generative content can include text, photos, video, audio, a selection of available content, and/or any other combination thereof. In some implementations, the generative content can comply with the one or more constraints determined for the form document. For example, generative content such as an image can be provided according to parameters that satisfy the one or more constraints (e.g., resolution, dimensions, subject matter, etc.).

Alternatively, or additionally, the generative content can include text that complies with the one or more constraints. For example, the one or more constraints can include a determined tone or linguistic style for the text to be input to a particular field. Alternatively, or additionally, the one or more constraints can indicate the type of content to be provided to a field, and the generative content can generate that content based on information that is available to the generative model with proper permission from the user. For example, the generative model may have been trained using documents stored in association with the user, with prior permission from the user, and those documents may include a resume and/or other work-related materials. Therefore, when the one or more constraints indicate that a particular field may be soliciting a summary of certain work experience, the generative content can be provided based on documents related to those constraints (e.g., the relationship being determined based on latent distance between embeddings in a latent space).

The method 300 can proceed from the operation 306 to an operation 308, which can include determining whether the user interacted with the interface output. In some implementations, the interface output can include a GUI element that is rendered at or near the form document and/or a field of the form document. In some implementations, the interface output can include audio, graphics, haptic, output, and/or any other output that can be rendered by a computing device. In some implementations, the interface output can include or refer to the generative content, thereby allowing the user to preview the generative content before selecting the generative content for a particular field of the form document.

In some implementations, before or after interacting with the interface output, the user can provide an input for modifying the generative content. For example, one or more interface elements can be rendered for putting the user on notice that additional input can be provided for certain parameters that influence the creation of the generative content. In this way, when the generative content has been suggested and/or selected, the user can still provide input for adjusting the generative content and/or any related parameters. When the user is determined to not have interacted with the interface output, the method 300 can proceed from the operation 308 to an operation 310. The operation 310 can include determining whether the user provided input to the particular field of the form document. When the user is determined to not have provided input to the particular field, the method 300 can proceed from the operation 310 to the operation 302, and/or another suitable operation. However, when the user is determined to have provided input to the particular field, the method 300 can proceed from the operation 310 to an operation 306. The interface output can then be regenerated based on the input that the user provided to, or selected for, one or more fields of the form document.

Returning to the operation 308, when the user is determined to have further interacted with the interface output, the method 300 can proceed from the operation 308 to an operation 312. The operation 312 can include determining generative content based on the one or more constraints and/or interface interaction. For example, when the interface output is a GUI element with one or more elements that can be adjusted, further interaction with the interface output can include an adjustment of a GUI element. For example, adjustment of a GUI element for a text field can modify one or more parameters of the generative model that was utilized to generate generative content for the particular field. As a result, the generative content may re-generated according to the one or more adjusted parameters.

As an example, when the one or more parameters affect a linguistic style and/or tone of the generative text content, interaction with a GUI element can cause replacement text to be generated for the particular field and according to the adjusted parameter. In some implementations, the user can interact with one or more GUI elements to modify one or more parameters that affect a degree to which the generative content satisfies one or more constraints. For example, a first GUI element may be adjusted to satisfy an express constraint. Alternatively, or additionally, another GUI element can be adjusted to modify one or more parameters for causing the generative content to satisfy a generative constraint. In this way, the user can interact with the interface output via multiple GUI elements to control, for example, a tone of generative text and an express word limit for the generative text. Alternatively, or additionally, the user can interact with the one or more GUI elements to filter candidate images according to their resolution and/or according to how professional they may appear. The method 300 can proceed from the operation 312 to an operation 314, which can include causing the generative content to be stored in association with the particular field. The method 300 can be performed for a single document and/or multiple documents that are accessible via one application or multiple different applications at a time.

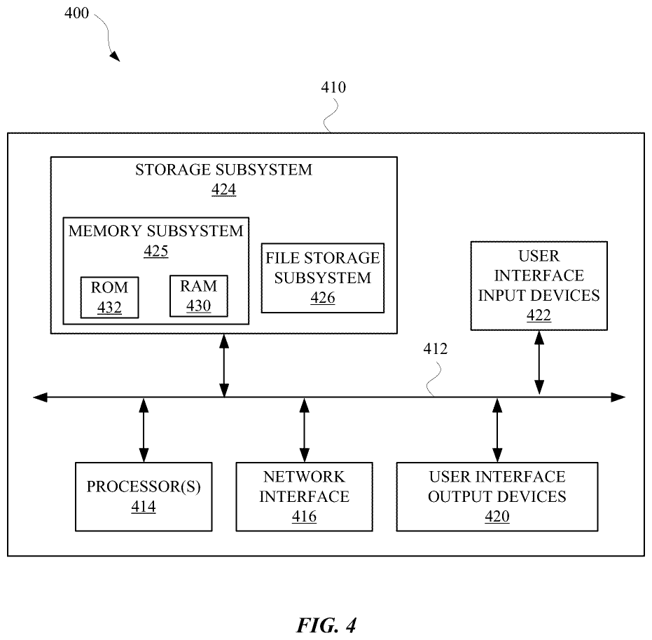

FIG. 4 is a block diagram 400 of an example computer system 410. Computer system 410 typically includes at least one processor 414 which communicates with a number of peripheral devices via bus subsystem 412. These peripheral devices may include a storage subsystem 424, including, for example, a memory 425 and a file storage subsystem 426, user interface output devices 420, user interface input devices 422, and a network interface subsystem 416. The input and output devices allow user interaction with computer system 410. Network interface subsystem 416 provides an interface to outside networks and is coupled to corresponding interface devices in other computer systems.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 410 to the user or to another machine or computer system.

Storage subsystem 424 stores programming and data constructs that provide the functionality of some or all of the modules described herein. For example, the storage subsystem 424 may include the logic to perform selected aspects of method 300, and/or to implement one or more of system 200, computing device 104, automated assistant, and/or any other application, device, apparatus, and/or module discussed herein.

These software modules are generally executed by processor 414 alone or in combination with other processors. Memory 425 used in the storage subsystem 424 can include a number of memories including a main random access memory (RAM) 430 for storage of instructions and data during program execution and a read only memory (ROM) 432 in which fixed instructions are stored. A file storage subsystem 426 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 426 in the storage subsystem 424, or in other machines accessible by the processor(s) 414.

Bus subsystem 412 provides a mechanism for letting the various components and subsystems of computer system 410 communicate with each other as intended. Although bus subsystem 412 is shown schematically as a single bus, alternative implementations of the bus subsystem may use multiple busses.

Computer system 410 can be of varying types including a workstation, server, computing cluster, blade server, server farm, or any other data processing system or computing device. Due to the ever-changing nature of computers and networks, the description of computer system 410 depicted in FIG. 4 is intended only as a specific example for purposes of illustrating some implementations. Many other configurations of computer system 410 are possible having more or fewer components than the computer system depicted in FIG. 4.

In situations in which the systems described herein collect personal information about users (or as often referred to herein, “participants”), or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

We claim:

1. A method implemented by one or more processors, the method comprising:
processing, using a generative model, form document data characterizing a form document that includes one or more fields that can receive input from a user of an application that is providing access to the form document;
determining, based on processing the form document data, one or more constraints for a particular field of the form document,
wherein the one or more constraints characterize a generative limitation and/or an express limitation for input content for the particular field of the form document;
causing, based on the one or more constraints, an interface output to be rendered in association with the particular field of the form document,
wherein the interface output indicates that generative content is available, or can be made available, for incorporating into the particular field of the one or more fields;
determining that the user interacted with the interface output and/or the application in furtherance of incorporating the generative content into the particular field of the one or more fields;
determining, based on the one or more constraints, the generative content to be included into the particular field of the one or more fields,
wherein the generative content is determined according to the generative limitation and/or the express limitation for the particular field of the form document; and
causing the generative content to be stored in association with the particular field of the form document.

2. The method of claim 1,
wherein the one or more constraints characterize the express limitation, and
wherein the express limitation corresponds to a particular constraint that is expressly indicated by certain content of the form document and limits the input received from the user at the particular field.

3. The method of claim 1,
wherein the one or more constraints characterize the generative limitation, and
wherein the generative limitation is determined using the generative model, or a different generative model, to process the form document data and/or other available data that is associated with the form document.

4. The method of claim 3, wherein determining the generative content to be included into the particular field of the one or more fields includes:
selecting, based on the generative limitation and/or the express limitation, a file that is stored in association with the application and/or the user.

5. The method of claim 4,
wherein the generative content includes an image, a video, and/or a document that is accessible to the application and/or the generative model, and
wherein the one or more constraints include the generative limitation, which indicates a limitation for a particular property for the file that includes the image, the video, and/or the document.

6. The method of claim 4,
wherein the generative content includes an image, a video, and/or a document that is accessible to the application and/or the generative model, and
wherein the one or more constraints include the express limitation, which indicates a size limitation or quality limitation for the file that includes the image, the video, and/or the document.

7. The method of claim 1, further comprising:
determining that the user subsequently interacted with the interface output and/or the application after the generative content was determined to be included into the particular field; and
causing, in response to the user subsequently interacting with the interface output, different generative content to be determined according to the generative limitation and/or the express limitation.

8. The method of claim 1,
wherein the interface output corresponds to one or more graphical user interface (GUI) elements that are selectable via an application GUI, and
wherein user interaction with the one or more GUI elements causes one or more content parameters associated with the generative limitation and/or the express limitation to be adjusted.

9. The method of claim 8,
wherein the one or more constraints include the generative limitation, and
wherein the one or more parameters of the generative limitation include a linguistic profile parameter for the generative content.

10. The method of claim 8,
wherein the one or more constraints include the express limitation, and
wherein the one or more parameters of the express limitation include a size for the generative content.

11. The method of claim 1, wherein processing the form document data includes:
processing, using the generative model or a different generative model, input data corresponding to information provided by the user to the application and/or a different application,
wherein the one or more constraints for the particular field are further based on processing the input data.

12. The method of claim 1, wherein processing the form document data includes:
processing, using the generative model or a different generative model, input data corresponding to other information provided by a different user to a separate instance of the application and/or a different application,
wherein the one or more constraints for the particular field are further based on processing the input data.

13. The method of claim 1, wherein determining the generative content to be included into the particular field of the one or more fields includes:
processing the form document data according to a retrieval-augmented generation process for enhancing a query to a particular generative model.

14. A method implemented by one or more processors, the method comprising:
processing, using a generative model, form document data characterizing a form document that includes one or more fields that can receive input from a user of an application that is providing access to the form document;
determining, based on processing the form document data, an express constraint for a particular field of the form document,
wherein the express limitation is expressly indicated by certain content of the form document and limits the input received from the user at the particular field;
determining, based on processing the form document data, that the user has provided initial input to the particular field of the form document;
causing a retrieval-augmented generation (RAG) process to be initiated in response to the user providing the initial input to the particular field of the form document,
wherein the RAG process utilized the initial input and the express constraint for determining generative content for the particular field; and
causing the generative content to supplement and/or replace the initial input to the particular field of the form document,
wherein the generative content satisfies the express limitation determined for the particular field.

15. The method of claim 14, further comprising:
causing an interface output to be rendered in association with the particular field of the form document,
wherein causing the generative content to supplement and/or replace the initial input is performed in response to the user interacting with the interface output.

16. The method of claim 15, further comprising:
determining that the user performed an input gesture in furtherance of interacting with the interface output and/or the form document,
wherein the input gesture affects the generative content to be provided into the particular field.

17. The method of claim 16, wherein the input gesture causes a linguistic style of the generative content to be modified relative to an original linguistic style of the initial input.

18. A method implemented by one or more processors, the method comprising:
processing, using a generative model, form document data characterizing a form document that includes one or more fields that can receive input from a user of an application that is providing access to the form document;
determining, based on processing the form document data, one or more constraints for a particular field of the form document,
wherein the one or more constraints characterize a generative limitation and/or an express limitation for input content for the particular field of the form document;
causing, based on the one or more constraints, one or more graphical user interface (GUI) elements to be rendered in association with the form document,
wherein interacting with the one or more GUI elements causes one or more parameters for generating content to be modified according to a type of gesture received at the one or more GUI elements;
determining that the user interacted with the one or more GUI elements in furtherance of incorporating the generative content into the particular field of the one or more fields;
determining, based on the one or more constraints and an interaction with the one or more GUI elements, the generative content to be included into the particular field of the one or more fields,
wherein the generative content is determined according to the one or more constraints and the interaction with the one or more GUI elements; and
causing the generative content to be rendered at the particular field of the form document.

19. The method of claim 18, wherein the interaction with the one or more GUI elements includes a swipe gesture that causes the generative content to replace existing content in the particular field of the form document.

20. The method of claim 19, wherein the swipe gesture further cases other content in another field of the form document to be modified based on the generative content.
